(19) United States
(12) Patent Application Publication
(10) Pub. No.: US 2025/0093823 A1
(43) Pub. Date: Mar. 20, 2025

(54) WEARABLE ELECTRONIC DEVICE

(71) Applicant: Apple Inc., Cupertino, CA (US)

(72) Inventor: Vladimir Krneta, San Jose, CA (US)

(21) Appl. No.: 18/470,984

(22) Filed: Sep. 20, 2023

(51) Int. Cl. G04G 17/04; G04G 21/00; G06F 1/16

(52) U.S. Cl. CPC G04G 17/045; G04G 21/00; G06F 1/163; G06F 1/1647; G06F 1/1686

(57) ABSTRACT

A wearable device includes a frame including a fixed portion and a movable portion. The wearable device includes a band connected to the fixed portion. The wearable device includes a display assembly positioned on the movable portion. The wearable electronic device includes an optical sensor positioned adjacent to the display assembly.

### FIELD

The described embodiments relate generally to electronic devices. More particularly, the present disclosure relates to wearable electronic devices.

### BACKGROUND

Electronic devices are increasingly being designed with device portability in mind to allow users to use these devices in a wide variety of situations and environments. In the context of wearable devices, these devices can be designed to include many different functionalities and to operate in many different locations and environments. As evidence of the advances in wearable technology in particular, many individuals already forego the use of a smartphone during exercise or periods of recreation and instead use a smartwatch. However, current wearable electronic devices are limited in terms of screen size and functionality relative to their smartphone counterparts. For this reason, smartphones are often preferred for many device interactions, and individuals do not typically leave their smartphones for extended periods of time. Therefore, there is a constant need for improved functionality of wearable electronic devices.

### SUMMARY

According to one example, a wearable electronic device includes a frame including a fixed portion and a movable portion. The wearable electronic device includes a band connected to the fixed portion. The wearable electronic device includes a display assembly positioned on the movable portion. The wearable electronic device includes an optical sensor positioned adjacent to the display assembly.

In at least one example of the wearable electronic device, the display assembly defines an aperture, and the optical sensor is optically aligned with the aperture.

In at least one example of the wearable electronic device, the display assembly includes an outer display, and the optical sensor faces outward with the outer display.

In at least one example of the wearable electronic device, the optical sensor is at least partially surrounded by an active display region of the display assembly.

In at least one example, the wearable electronic device further includes an additional display assembly positioned on the fixed portion and on an inner side of the movable portion, the additional display assembly including an inner display.

In at least one example of the wearable electronic device, the inner display is a continuous display.

In at least one example, the wearable electronic device further includes a hinge rotatably connecting the fixed portion and the movable.

In at least one example of the wearable electronic device, the movable portion is rotatable about a first axis of rotation relative to the fixed portion.

In at least one example of the wearable electronic device, the movable portion is rotatable about a second axis of rotation relative to the fixed portion, the second axis of rotation being perpendicular to the first axis of rotation.

In at least one example of the wearable electronic device, the wearable electronic device includes a rotatable portion positioned in-plane with the fixed portion, the rotatable portion being rotatable about an axis perpendicular to the fixed portion

According to one example, a portable electronic device includes a housing with an exterior housing and an interior housing. The exterior housing defines an exterior opening and a first interior opening, and the interior housing defines a second interior opening. The portable electronic device includes a hinge rotatably connecting the exterior housing and the interior housing. The portable electronic device includes an exterior display positioned within the exterior opening, the exterior display defining a first camera aperture. The portable electronic device includes a first camera optically aligned with the first camera aperture. The portable electronic device includes an extended interior display opposite the exterior display and positioned within the first interior opening and the second interior opening, the extended interior display defining a second camera aperture. The portable electronic device includes a second camera optically aligned with the second camera aperture.

In at least one example of the portable electronic device, the first camera faces outward, and the second camera faces inward.

In at least one example of the portable electronic device, a first field of view of the first camera and a second field of view of the second camera are adjustable via adjustment of the exterior housing.

In at least one example of the portable electronic device, a data representation of at least one the first field of view or the second field of view is transmittable to an external client.

In at least one example of the portable electronic device, the extended interior display includes discrete, discontinuous displays.

In at least one example of the portable electronic device, the extended interior display includes a continuous display configured to render a singular graphical representation.

According to one example, a smartwatch includes a housing. The smartwatch includes a movable display including a first side with a first display surface and a second side with a second display surface, the second side being opposite the first side, and the movable display being connected to the housing and movable relative to the housing between an open state and a closed state. The smartwatch can include a camera positioned on the movable display. The smartwatch includes a display support attaching the movable display to the housing. The smartwatch includes a strap connected to the housing.

In at least one example of the smartwatch, the display support includes a stop at a predetermined angle of the movable display in the open state.

In at least one example of the smartwatch, the display support pivotally attaches the movable display to the housing.

In at least one example of the smartwatch, the movable display includes a foldable display with a folding region positioned adjacent to the display support.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows an example of an electronic device, according to one example;

FIG. 1B illustrates a top perspective view of the electronic device without a strap, according to one example;

FIG. 1C shows a bottom perspective view of the electronic device without the strap, according to one example;

FIG. 2 illustrates an exploded view of an electronic device, according to one example;

FIG. 3A illustrates a perspective view of a foldable electronic device in a closed configuration, according to one example;

FIG. 3B illustrates a side view of the foldable electronic device in the closed configuration, according to one example;

FIG. 4A illustrates a perspective view of a foldable electronic device with a discontinuous display in an open configuration, according to one example;

FIG. 4B illustrates a perspective view of a foldable electronic device with a continuous display in an open configuration, according to one example;

FIG. 4C illustrates a side view of a foldable electronic device in an open configuration, according to one example;

FIG. 5 illustrates a side view of a foldable electronic device with an optical sensor, according to one example;

FIG. 6 illustrates a side view of a foldable electronic device with a first camera and a second camera, according to one example;

FIG. 7A illustrates a perspective view of an electronic device with a display rotatable about a first axis of rotation and a second axis of rotation, according to one example;

FIGS. 7B-7C illustrate a perspective view of an electronic device with a rotatable portion relative to a fixed base; and

FIG. 8 illustrates an electronic device including a movable portion, which is slidable with respect to a fixed portion, according to one example.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure generally relates to electronic devices. More particularly, the present disclosure relates to wearable electronic devices. The wearable electronic devices of the present disclosure include tailored arrangements of components to provide additional or enhanced functionality, without introducing or increasing undesirable device properties or performance. In this way, more functionality and componentry can be included in wearable devices for users to wear and operate in various conditions or activities.

In particular examples, the disclosure relates to a wearable electronic device (e.g., a smartwatch) that can supplant the need for utilizing other electronic devices (e.g., a smartphone) for at least a period of time. In one or more examples of the present disclosure, the wearable electronic device can provide increased screen size and functionality than heretofore achieved in wearable electronic devices. Indeed, the screen size and functionality of the disclosed wearable electronic device is more similar to a smartphone and allows users the flexibility to substitute the wearable electronic device for a smartphone for extended periods of time or for use in more routine activities typically performed with a smartphone. For example, the wearable electronic device of the present disclosure can provide intuitive access and enhanced usability of features for convenient video calling, camera usage, web browsing, messaging, and interfacing social media. Moreover, the wearable electronic device can provide the foregoing advantages while also having a stowed (or closed) configuration for desired portability.

In one example, a wearable electronic device, such as a smartwatch, can include a display with an extendable screen size. In particular, the display can be folded to be compact, and the display can be extended when increased screen size is desired. A user may want the display to be extended when using certain applications, making phone/video calls, playing games, browsing the web, etc. On the other hand, the user may want the display to be folded for convenience and portability, such as when the user is going about their day-to-day activities, outdoor activities, etc. In at least one example, in the folded configuration, the wearable electronic device can have an additional display to provide more simplistic functionalities, such as displaying time, notifications, weather, health information, a media interface, etc. It will be appreciated that the display can be extended in many different ways (e.g., via sliding components, hinged components, pivoting components, etc.). Additionally or alternatively, the display can include a wider or otherwise larger display screen (e.g., for enhanced viewing and device interactions).

In at least one example, the wearable electronic device can include an exterior camera, which can be used both in the folded configuration and the extended configuration, as well as an interior camera that can be used in the extended configuration. The interior camera can allow the user to use the wearable electronic device for various applications such as video or conference calling.

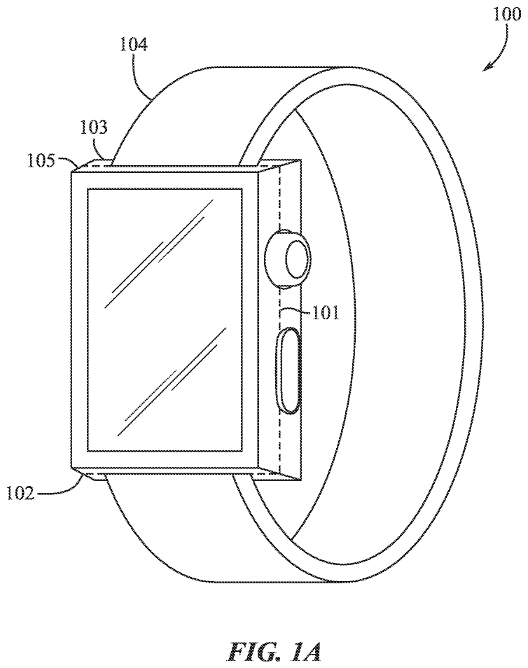

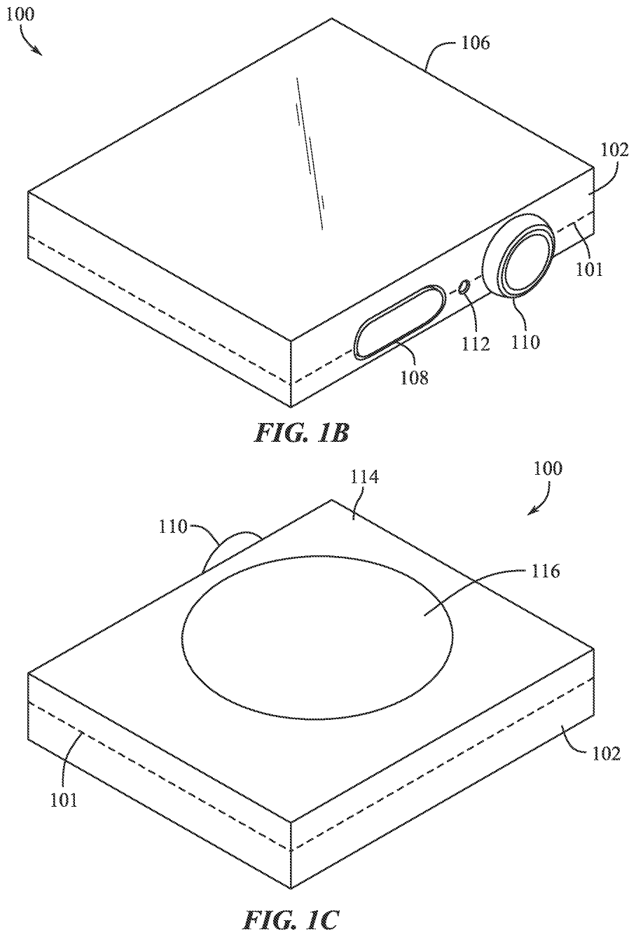

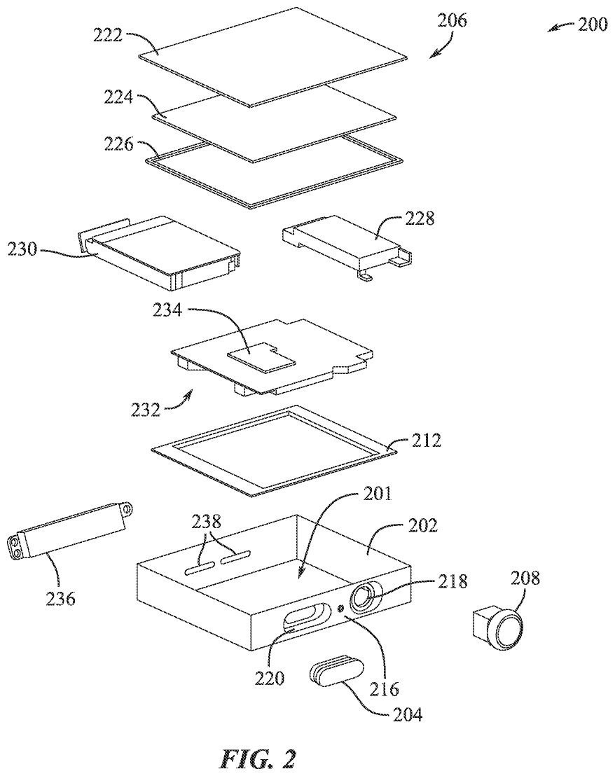

These and other embodiments are discussed below with reference to FIGS. 1-8. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows an example of an electronic device 100, according to one example. The electronic device 100 can be a wearable electronic device or a portable electronic device. For example, the electronic device shown in FIG. 1A can be a watch, such as a smartwatch (e.g., a watch having communication capabilities, messaging capabilities, internet capabilities, sensor capabilities, integration with software apps on other devices, etc.) or an electronic watch. The electronic device 100 of FIG. 1A is a representative example of a device that can be used in conjunction with the systems and methods disclosed herein. For example, the electronic device 100 can correspond to any form of wearable electronic device, a portable media player, a media storage device, a portable digital assistant (“PDA”), a tablet computer, a computer, a mobile communication device, a GPS unit, a remote-control device, or other electronic device. The electronic device 100 can also be referred to as a consumer device.

In some examples, the electronic device 100 can include a housing 102 that can carry operational components, for example, in an internal volume at least partially defined by the housing 102. The housing 102 can be a frame which carries the operational components. The housing 102 (e.g., the frame) can include a fixed portion 103 and a movable portion 105 that are separated by an interface 101. The electronic device 100 can also include a strap 104, or other retaining component, such as a band, that can secure the electronic device 100 to a body of a user as desired. Further details of the electronic device 100 are provided below with reference to FIG. 1B.

FIG. 1B illustrates a top perspective view of the electronic device 100 without the strap 104, according to one example. The electronic device 100 can be, for example, a portable electronic device or a wearable electronic device, such as a smartwatch or an electronic watch, that can be substantially similar to and can include some or all of the features of the devices described herein, including the electronic device 100 shown in FIG. 1A but without the strap 104. The electronic device 100 can include a housing 102, and a display assembly 106 attached to the housing 102. The housing 102 can substantially define at least a portion of an exterior surface of the device 100.

The display assembly 106 can be a display module. The display assembly 106 can include a display cover. The display cover can be a glass, a plastic, or any other substantially transparent exterior layer, material, component, or assembly. The display assembly 106 can include multiple layers, with each layer providing a unique function, as described herein. Accordingly, the display assembly 106 can be, or can be a part of, an interface component. The display assembly 106 can define a front exterior surface of the electronic device 100 and, as described herein, this exterior surface can be considered an interface surface. In some examples, the interface surface defined by display assembly 106 can receive inputs, such as touch inputs, from the user.

In some examples, the housing 102 can be a substantially continuous or unitary component and can define one or more openings to receive components of the electronic device 100. In some examples, the electronic device 100 can include input components such as one or more buttons 108 and/or a crown 110 that can be disposed in the openings. In some examples, a material can be disposed between the buttons 108 and/or crown 110 and the housing 102 to provide an airtight and/or watertight seal at the locations of the openings. The housing 102 can also define one or more openings or apertures, such as aperture 112 that can allow for sound to pass into or out of the internal volume defined by the housing 102. For example, the aperture 112 can be in communication with a microphone component disposed in the internal volume. In some examples, the housing 102 can define or include a feature, such as an indentation to removably couple the housing 102 and a strap or retaining component.

FIG. 1C shows a bottom perspective view of the electronic device 100 without the strap, according to one example. The electronic device 100 can include a back cover 114 that can be attached to the housing 102, for example, opposite the display assembly 106. The back cover 114 can include ceramic, plastic, metal, or combinations thereof. In some examples, the back cover 114 can include an at least partially electromagnetically transparent component 116. The electromagnetically transparent component 116 can be transparent to any desired wavelengths of electromagnetic radiation, such as visible light, infrared light, radio waves, or combinations thereof. In some examples, the electromagnetically transparent component 116 can allow sensors and/or emitters disposed in the housing 102 to communicate with the external environment. Together, the housing 102, display assembly 106 and back cover 114 can substantially define an internal volume and an external surface of the device 100.

Although not explicitly illustrated, examples of electronic devices disclosed herein can include components, features, arrangements, and configurations that resists damage and corrosion due to exposure to moisture. Some aspects of devices described herein can include gaps between components through which moisture, water, or other fluids could enter. The gaps may be present for aesthetic purposes or for functional purposes. However, one or more components, including epoxy seals, insulating materials and frames, and other components of devices described herein can be configured to prevent such moisture from entering into the internal volume of the device where sensitive electronic component could be damaged thereby.

As noted above, portable and/or wearable electronic devices can be designed for use in many different environments and during any kind of activity throughout a user's day. For example, wearable electronic watches, headphones, and phones can be carried by a user during exercise, sleep, driving, biking, hiking, swimming, diving, outside in the rain, outside in the sun, and so forth. As such, the wearable device can be designed to serve additional functionality, such as functioning both as a wearable device as well as a communication device, such as a phone.

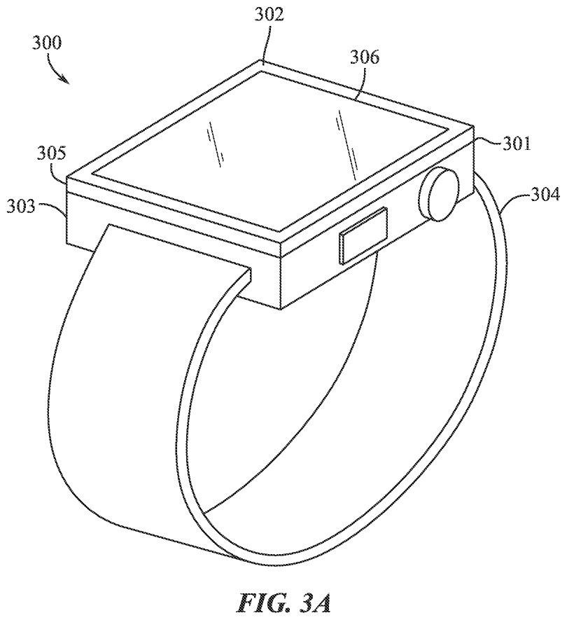

Any of the features, components, and/or parts, including the arrangements and configurations thereof shown in FIGS. 1A-1C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1A-1C. Additional details of the electronic device are provided below with reference to FIG. 2.

FIG. 2 illustrates an exploded view of an electronic device 200, according to one example. The electronic device 200 can be a smartwatch substantially similar to, and can include some or all of the features of, the devices described herein, such as the electronic device 100. The electronic device 200 can include a housing 202, a display assembly 206, and a back cover 212. Together, the housing 202, display assembly 206, and back cover 212 can define an exterior surface and an internal volume of the electronic device 200.

The housing 202 can be a substantially continuous or unitary component, and can define one or more openings 216, 218, 220 to receive components of the electronic device 200 and/or to provide access to an internal portion of the electronic device 200. In some examples, the electronic device 200 can include input components such as one or more buttons 204 and/or a crown 208 that can be disposed in the openings 220, 218. A microphone can be disposed in the internal volume in communication with the external or ambient environment through the opening 216.

The display assembly 206 can be received by, and can be attached to, the housing 202. The display assembly 206 can include a cover 222 including a transparent material, such as plastic, glass, and/or ceramic. The display assembly 206 can also include a display layer 224 that can include multiple layers and components, each of which can perform one or more desired functions. For example, the display layer 224 can include a layer that can include a touch detection layer or component, a touch sensitive layer 246, a force sensitive layer or component, and one or more display layers or components that can include one or more pixels and/or light emitting portions to display visual content and/or information to a user. In some examples, the display layer or component can include a liquid crystal display (LCD), a light emitting diode (LED) display, an organic light emitting diode (OLED) display, and/or any other form of display. The display layer 224 can also include one or more electrical connectors to provide signals and/or power to the display layer from other components of the electronic device 200. In at least one example, the housing 202 (e.g., the frame) can include a fixed portion and a movable portion. The display assembly 206 can be located at least partially on the movable portion.

In some examples, the electronic device 200 can include a gasket or seal 226 that can be disposed between the display assembly 204 and the housing 202 to substantially define a barrier to the ingress of liquids or moisture into the internal volume 201 from the external environment at the location of the seal 226. As described herein, the seal 226 can include polymer, metal, and/or ceramic materials. The electronic device 200 can also include a similar seal (not shown) that can be disposed between the housing 202 and the back cover 212 to substantially define a barrier to the ingress of liquids or moisture into the internal volume 201 from the external environment at the location of the seal. As described herein, the seal can include polymer, metal, and/or ceramic materials. The similar seal can be substantially similar to, and can include, some or all of the features of the seal 226.

The electronic device 200 can also include internal components, such as a haptic engine 228, an electrical power supply 230 (e.g., a battery), a speaker module 236, and a logic board 232, also referred to as a main logic board 232 that can include a system in package (SiP) 234 disposed thereon, including one or more integrated circuits, such as processors, sensors, and memory. Specifically, the processors, sensors, and memory can be located within the internal volume of the housing 202. The device 200 of FIG. 2 is shown in an exploded view and it is noted that the SiP 234 and speaker module 236 can be disposed in the internal volume when the device 200 is assembled.

In some examples, internal components can be disposed below the main logic board 232 and can be disposed at least partially in a portion of the internal volume defined by the back cover 212. In some examples, the electronic device 200 can include one or more wireless antennas (not shown) that can be in electrical communication with one or more other components of the electronic device 200. In some examples, the antenna(s) can receive and/or transmit wireless signals at one or more frequencies and can be, for example, one or more of a cellular antenna such as a long-term evolution (LTE) antenna, a Wi-Fi antenna, a Bluetooth antenna, a GPS antenna, a multi-frequency antenna, and the like. The antenna(s) can be communicatively coupled to one or more additional components of the electronic device 200.

In some examples, the electronic device 200 can include a speaker assembly 236 disposed within the internal volume defined by the housing 202. The speaker assembly 236 can include one or more speakers that convert electrical signals into acoustic waves that are audible to humans at an environment external to the housing 202. For example, one or more apertures 238 can be formed within the housing 202, which place the speaker assembly in fluid communication with the environment external to the housing 202. The internal components can be disposed within the internal volume 201 defined at least partially by the housing 202 and can be affixed to the housing 202 via adhesives, internal surfaces, attachment features, threaded connectors, studs, posts, or other features, that are formed into, defined by, or otherwise part of the housing 202 and/or the back cover 212.

It will be appreciated that one or more of the foregoing components described in conjunction with FIG. 2 can be modified for use with an extendable display, a foldable display, a slidable display, a rotatable display, etc. as disclosed herein. Likewise, other components can be added thereto, including one or more optical sensors (e.g., cameras), additional display surfaces, etc.

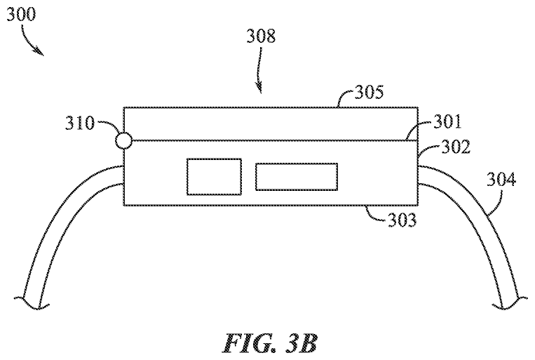

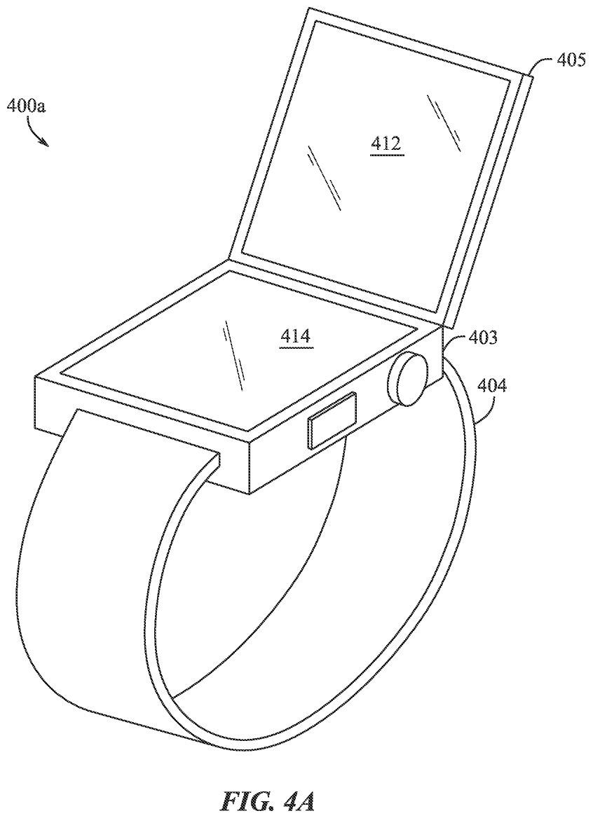

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Additional details of foldable electronic devices in a closed configuration are provided below in reference to FIGS. 3A-3B.

FIG. 3A illustrates a perspective view of a foldable electronic device 300 in a closed configuration, according to one example.

FIG. 3B illustrates a side view of the foldable electronic device 300 in the closed configuration, according to one example. Although not all components are necessarily shown, the electronic device 300 can be substantially similar to the electronic devices within this disclosure, as noted by similar reference numbers.

As described above, the electronic device 300 can be a smartwatch which includes a housing 302. The housing 302 can include a frame with a fixed portion 303 and a movable portion 305 that are separated by an interface 301. The fixed portion 303 can be referred to as an interior housing while the movable portion 305 can be referred to as an exterior housing. In other words, the housing 302 can include an interior housing and an exterior housing. A hinge 310 rotatably connects the exterior housing and the interior housing. A band 304 (strap or other retention mechanism) can be connected to the fixed portion 303.

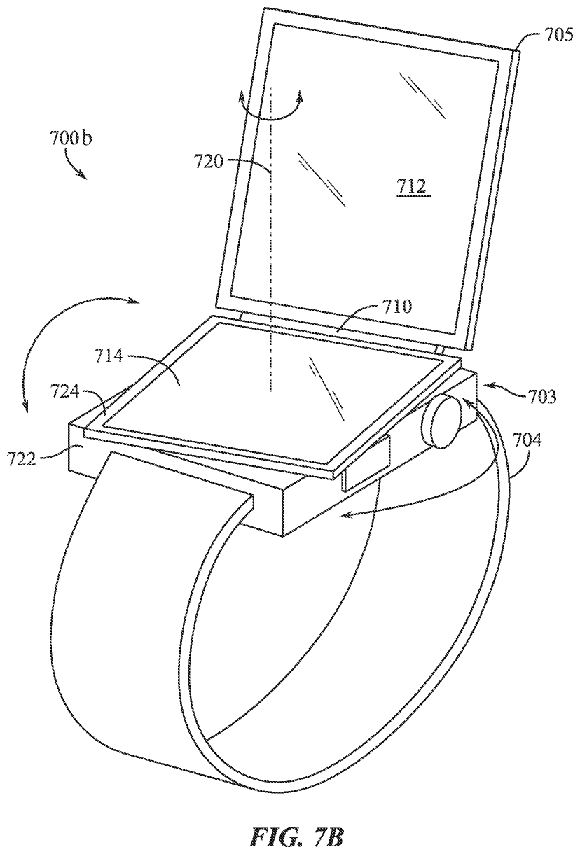

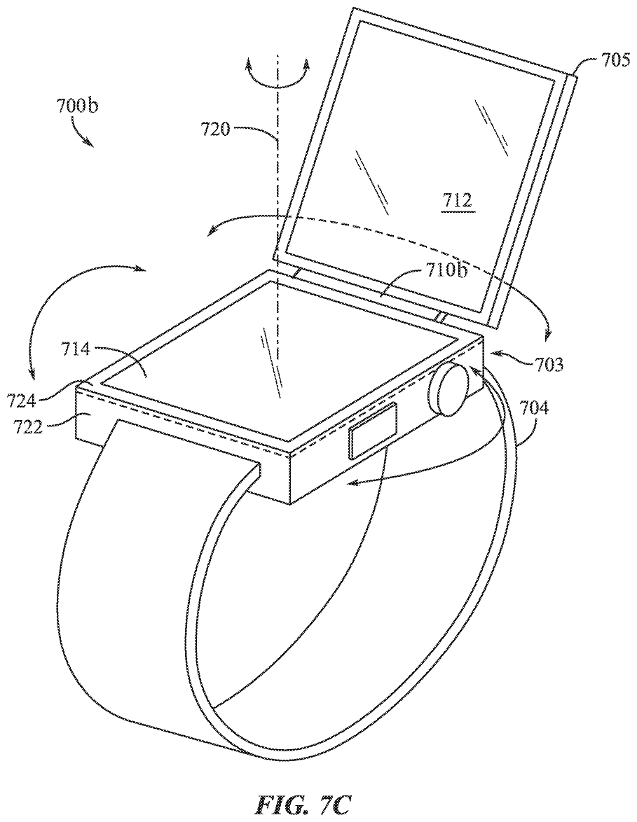

As illustrated in FIG. 3B, the electronic device 300 can include the hinge 310 rotatably connecting the fixed portion 303 to the movable portion 305. The movable portion 305 can be rotatable relative to the fixed portion 303, about an axis of rotation along the hinge 310 (e.g., “out of the page” in the illustration of FIG. 3B. The axis of rotation is illustrated as axis 715 in FIG. 7. As used herein, the axis of rotation refers to a straight line about which an object (in this case, the movable portion 305) can rotate.

The electronic device 300 can include a display assembly 306 positioned on the movable portion 305. The display assembly 306 can include an outer display 308. The outer display 308 can be a display screen to allow the user to interface with the electronic device 300 when the electronic device 300 is in the closed configuration. For example, the outer display 308 can display information including time, notifications, status (of the device 300), etc., and can allow the user to control various functions of the electronic device 300, such as volume, media, power, etc.

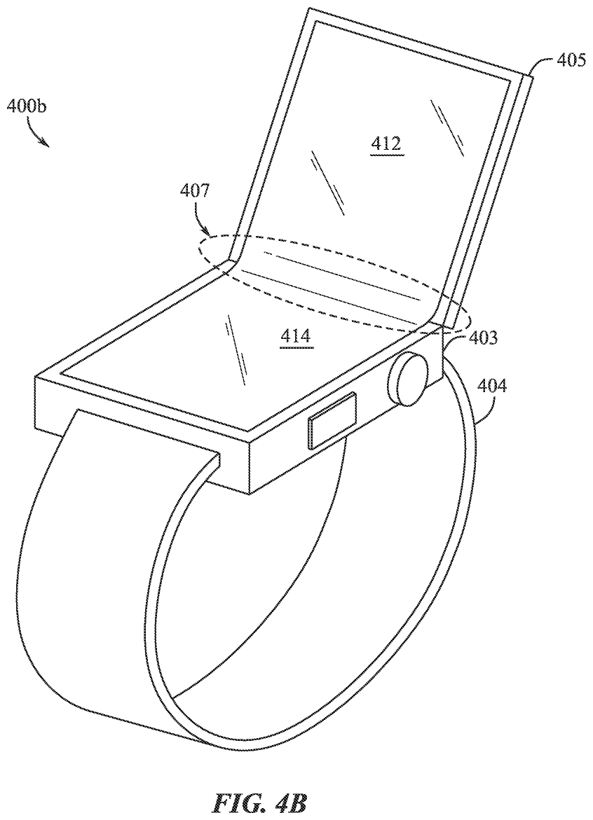

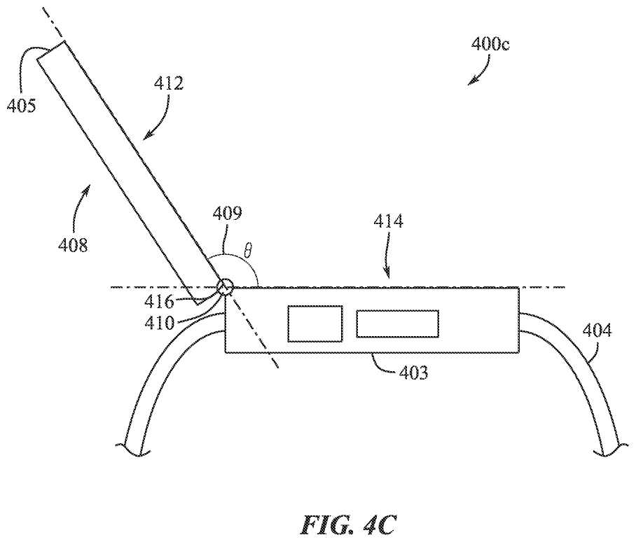

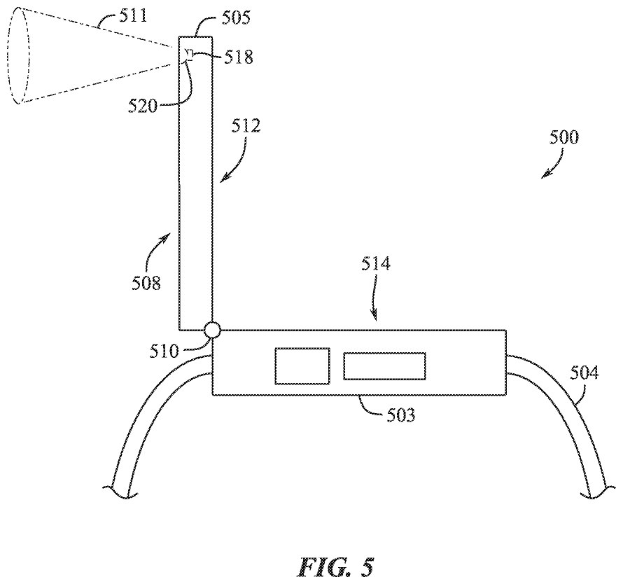

Any of the features, components, and/or parts, including the arrangements and configurations thereof shown in FIGS. 3A-3B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3A-3B. Additional details of foldable electronic devices in various open configurations are provided below in reference to FIGS. 4A-4C.

FIG. 4A illustrates a perspective view of a foldable electronic device 400a with a discontinuous display in an open configuration, according to one example.

FIG. 4B illustrates a perspective view of a foldable electronic device 400b with a continuous display in an open configuration, according to one example.

FIG. 4C illustrates a side view of a foldable electronic device 400c in an open configuration, according to one example. The electronic device 400c can be either of the electronic devices 400a or 400b. As such, the electronic devices 400a-c can be referred to collectively as an electronic device 400 where appropriate. Although not all components are necessarily shown, the electronic device 400 can be substantially similar to the electronic device 300, as noted by similar reference numbers. For example, the electronic device 400 can include an exterior housing 403 similar to the fixed portion 303. The electronic device can include an interior housing 405 similar to the movable portion 303 of the housing. The electronic device 400 can include a band 404.

The electronic device 400a can include a display assembly, such as the display assembly 306 of FIG. 3 (not illustrated in FIG. 4A). The electronic device 400 can include an additional display assembly positioned on the fixed portion (e.g., the interior housing 403) and on an inner side of the movable portion (e.g., the exterior housing 405). The additional display assembly can include an inner display 412 and 414. The inner display 412 is positioned on an inner side of the movable portion (or exterior housing 405), and the inner display 414 is positioned on a face-up side of the fixed portion (or interior housing 403).

The exterior housing 405 can define an exterior opening and a first interior opening, opposite the exterior opening. The interior housing 403 can define a second interior opening. An exterior display 408 can be positioned within the exterior opening. The electronic device 400 can further include the inner displays 412, 414 (described above) as an extended interior display positioned within the first interior opening and the second interior opening, respectively. The extended interior display (i.e., inner display 412) can be located opposite the exterior display 408. In at least one example, the other extended interior display (i.e., inner display 414) can be located opposite a bottom face (or skin-facing surface) of the fixed portion. Further, and as described below, the inner displays 412, 414 can be discrete, discontinuous displays (e.g., two separate displays adjacent each other). In other examples, the inner displays 412, 414 can form a continuous display (e.g., a single, uniform display with no separation between pixels from end-to-end of the display).

In at least one example, the electronic device 400 can include a hinge 410. In at least one example, the hinge 410 can be a friction hinge. In additional or alternate examples, the hinge 410 can be a type of pie-cut hinge, barrel hinge, butt hinge, wrap-around hinge, or the like. The hinge 410 can be located either external to the exterior housing 405 and the interior housing 403; or the hinge 410 can be built to be hidden between the external housing 405 and the interior housing 403.

The hinge 410 can be a display support attaching the exterior housing 405 to the interior housing 403. In particular, the hinge 410 can pivotally and rotatably attach the exterior housing 405 to the interior housing 403. In other words, the display support can pivotally attach the exterior housing 405 to the housing. The hinge 410 can allow the exterior housing 405 to rotate about an axis of rotation that is “out of the page” (i.e., perpendicular to the page) and located at the hinge 410. The hinge 410 can be a friction hinge or other appropriate hinge which can maintain a position of the exterior housing 405 at a user-defined position about the axis of rotation.

The hinge 410 can include a stop 416 at a predetermined angle θ. As shown in FIG. 4C, the predetermined angle θ can be defined as an angle formed between the planar surfaces of the inner display 412 and the inner display 414. In some examples, the predetermined angle θ can be between 90 degrees and 120 degrees. In some examples, the predetermined angle θ can range between 100 degrees and 180 degrees. The stop 416 can be a mechanism or component disposed exterior to the hinge 410 or built into the hinge 410, which can prevent the exterior housing 405 from pivoting away from the interior housing 403 by an angle greater than the predetermined angle θ in the open state (e.g., the open configuration). In other words, the exterior housing 405 can be rotated and positioned from the interior housing 403 by a user-preferred angle between 0 degrees and θ. The hinge 410 can support the exterior housing 405 at the user-preferred angle.

In at least one example, as shown in FIG. 4A, the extended interior display 412 and 414 includes discrete, discontinuous displays. The interior display 412 can be positioned within the first interior opening which is positioned on the exterior housing 405. The interior display 412 can be positioned within the second interior opening which is positioned on the interior housing 403. Each of the first interior opening and the second interior opening can be defined by a cutout in the exterior housing 405 and the interior housing 403, respectively. The cutouts can be closed and defined such that a frame formed by the exterior housing 405 and the interior housing 403 individually and fully surround an outer perimeter of the inner displays 412 and 414. In at least one example, the discrete, discontinuous displays can be configured to render a singular graphical representation spread across the discrete continuous displays. Graphical representations can include images, live feed, web content, books, social media content, graphical user interface, application interface, or the like.

In at least one example, as shown in FIG. 4B, the extended interior display 412 and 414 is instead a continuous display. The first interior opening and the second interior opening can be a single interior opening. Each of the first interior opening and the second interior opening can be defined by a cutout in the exterior housing 405 and the interior housing, respectively. The cutouts can be open and defined such that a frame formed by the exterior housing 405 and the interior housing 403 only partially surround an outer perimeter of the inner displays 412 and 414. For example, the folding region 407 (discussed below) may include a display portion that can move out of plane (e.g., pop out) relative to at least one of the exterior housing 405 or the interior housing 403. In other examples, the exterior housing 405 and the interior housing 403 can form a complete edge around the inner displays 412, 414.

The interior displays 412 and 414 can extend to connect with each other. Thus, the movable display can include a foldable display with a folding region 407 positioned adjacent the display support (hinge 410). In some examples, the folding region 407 forms a crease or visible line laterally across the foldable electronic device 400b. The crease may correspond to location where the inner display 412 adjoins the inner display 414. In some examples, the crease may include an inactive line (e.g., a non-displayable line) or a display edge with lower pixel resolution. In other examples, the folding region 407 comprises a creaseless transition (e.g., a natural display curvature or bend) between the inner displays 412, 414. For instance, the folding region 407 can include a pixel resolution that is the same as (or similar to) the pixel resolution of the inner displays 412, 414 such that the folding region 407 comprises displayable real estate (i.e., an active display area) for presenting a portion of a graphical representation.

In at least one example, the extended interior displays 412 and 414 can display images, videos, information, applications, etc. In the example shown in FIG. 4B, the extended interior displays 412 and 414 can display separate information. For example, the interior display 412 can display information such as time, calendar, map, images, video, etc., when the interior display 414 can display a keyboard, navigation directions, a home screen, etc. (Any combination of various applications can be displayed by either of the displays 412 and 414.) In other examples, the interior displays 414 can display a single view or a single graphical representation which is separated by the discontinuity of the displays.

Similarly, in the example shown in FIG. 4A, the extended interior displays 412 and 414 along with the folding region 407 can display a single view which is continuous across the folding region 407. Additionally or alternatively, the extended interior displays 412 and 414 can display separate information as in the example of FIG. 4B.

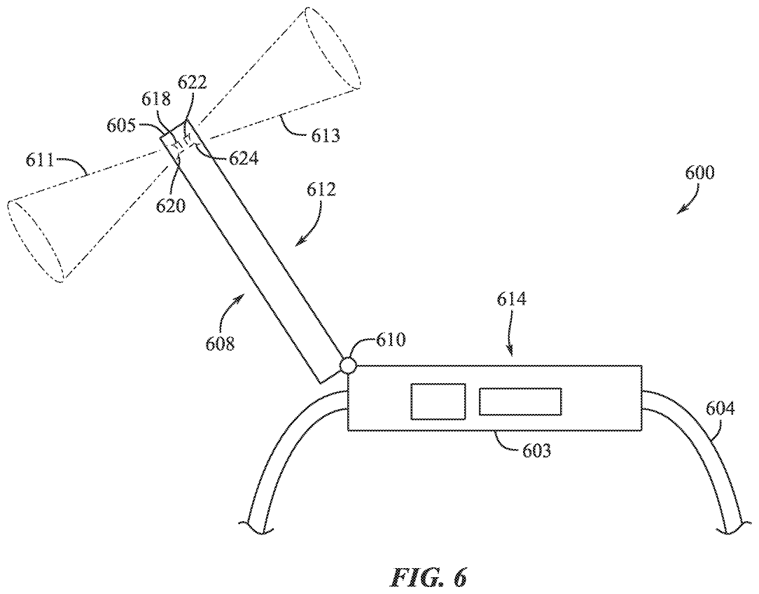

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4. Additional details of an optical sensor of foldable electronic devices are provided below in reference to FIG. 5.

FIG. 5 illustrates a side view of a foldable electronic device 500 with an optical sensor 520, according to one example. Although not all components are necessarily shown, the electronic device 500 can be substantially similar to the electronic device 300, as noted by similar reference numbers. The electronic device 500 can include a housing 503 (e.g., an inner housing) and a movable display 505 (e.g., an exterior housing). The movable display 505 (e.g., display assembly) can include a first side including a first display surface 508. The movable display 505 can include a second side including a second display surface 512. The housing 503 can include a third display surface 514. The movable display 505 can be connected to the housing 503 and can be movable relative to the housing 503 between an open state and a closed state. As illustrated in FIG. 5, the electronic device 500 is in the open state.

The electronic device can include an optical sensor 518 positioned adjacent to the display assembly or the movable display 505. The movable display 505 can define an aperture 520. The optical sensor 518 can be optically aligned with the aperture 520. The optical sensor 518 can face outward with the outward display or the first display surface 508. In particular, the optical sensor can face outward through the aperture 520. In certain examples, however, the optical sensor 518 may not be physically aligned with the aperture 520 (e.g., due to sensor size and/or available interior volume within the movable display 505). However, through the use of one or more optical elements (e.g., reflective elements), the optical sensor 518 can be optically aligned with the aperture 520 to receive optical signals from an external environment. The optical sensor 518 can be at least partially surround by an active display region of the movable display 505. In at least one example, the optical sensor 518 can be a camera. The first display surface 508 is an exterior display and can define the aperture 520 of the camera. In other examples, the optical sensor 518 can be a different type of sensor, such as an infrared sensor.

In at least one example, the optical sensor 518 can face outward and can be characterized by a field of view (FOV) 511. As used herein, an FOV refers to a detectable environment, area, peripheral view, or distance that can be detected by the optical sensor 518. In at least one example, the FOV 511 can be conical with a vertex located at the optical sensor 518. An axis (e.g., an optical axis or center) of the FOV 511 can be substantially perpendicular to the plane of the movable display 505. In at least one example, the FOV 511 can be adjustable via adjustment of the movable display 505. In particular, a direction of the axis of the FOV 511 can be rotated about the axis of rotation (located at the hinge 510) of the movable display 505 with respect to the housing 503. A data representation of the FOV 511 can be transmittable to an external client device, such as another smartwatch, cellular device, laptop, personal computer, etc.

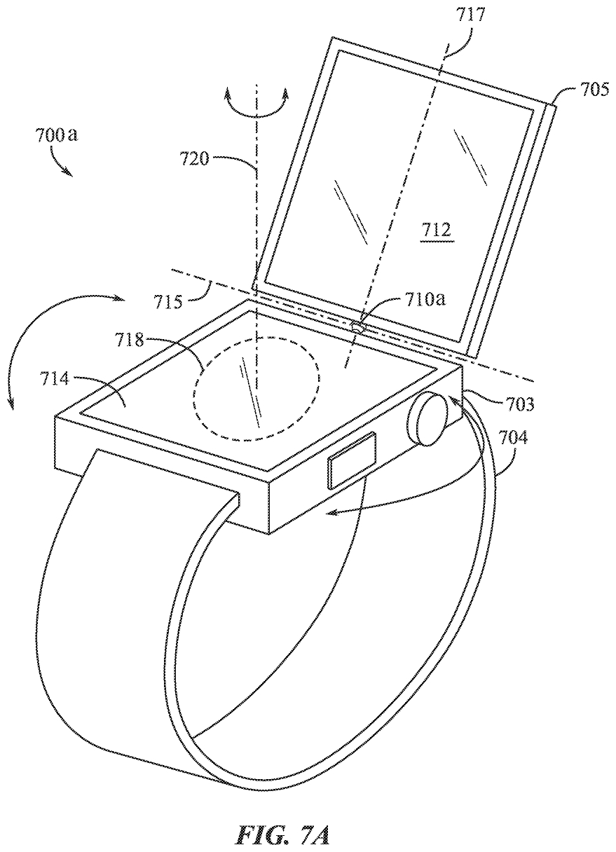

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5. Additional details of cameras of foldable electronic devices are provided below in reference to FIG. 6.

FIG. 6 illustrates a side view of a foldable electronic device 600 with a first camera 618 and a second camera 622, according to one example. Although not all components are necessarily shown, the electronic device 600 can be substantially similar to the electronic device 500, as noted by similar reference numbers.

The electronic device can include a band 604, a housing including an exterior housing 605 and an interior housing 603, a hinge 610, an exterior display 608, an extended interior display 612 and 614 opposite the exterior display 608, and cameras 620 and 622.

The exterior housing 605 can define an exterior opening and the exterior display 608 can be positioned within the exterior opening. The exterior housing 605 can also define a first interior opening. The interior housing 603 can define a second interior opening. The extended interior display 612 and 614 can be positioned within the first interior opening and the second interior opening. The hinge 610 can rotatably connect the exterior housing 605 and the interior housing 603.

The exterior display 608 can define a first camera aperture 620. The first camera 618 can be optically aligned with the first camera aperture 620. In particular, the first camera 618 can have a first FOV 611 characterized by a first direction which is optically aligned to be directed outward through the first camera aperture 620. In other terms, the first camera 618 faces outward in the direction of the exterior display 608.

A portion of the extended interior display 612 can define a second camera aperture 624. The second camera 622 can be optically aligned with the second camera aperture 624. In particular, the second camera 622 can have a second FOV 613 characterized by a second direction which is optically signed to be directed inward through the second camera aperture 624. In other terms, the second camera 622 faces inward in the direction of the inner display 612. In these or other examples, however, at least one of the first camera 618 or the second camera 622 may not be physically aligned with corresponding apertures 620, 624 (e.g., due to sensor size and/or available interior volume within the exterior housing 605). However, through the use of one or more optical elements (e.g., reflective elements), the first camera 618 and the second camera 622 can be optically aligned with the corresponding apertures 620, 624 to receive optical signals from an external environment.

The exterior housing 605 and the interior housing 603 can be rotatable coupled by the friction hinge 610. The first FOV 611 of the first camera 618 and the second FOV 613 of the second camera 622 can be adjustable via adjustment of the exterior housing. In particular, the directions first FOV 611 and the second FOV 613 can be adjusted by rotating the external housing 605 about the hinge 610 with respect to the internal housing 603. In at least one example, the second FOV 613 is directed in a direction opposite to the first FOV 511. In particular, the axes of the cones formed by the FOVs 611 and 613 can be parallel. In some further examples, the axes of the cones formed by the FOVs 611 and 613 can be parallel coincident.

A data representation of at least one of the first FOV 611 or the second FOV 613 can be transmittable to an external client device, such as another smartwatch, a cellular device, a laptop, a personal computer, etc. For example, a graphical representation or an image representation of the second FOV 613 obtained by the second camera 622 can be transmittable to the external client device for applications such as video calling or video conferencing. Similarly, a data representation of the second FOV 613 can be transmittable to the external client device. In at least one example, the user can alternate between transmitting the data representations of either of the FOVs 611 or 613. In some examples, the user can transmit the data representations of both of the FOVs 611 and 613 simultaneously.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6. Additional details of a hinge and rotatable elements of foldable electronic devices are provided below in reference to FIGS. 7A-7C.

FIG. 7A illustrates a perspective view of an electronic device 700a which is rotatable about a first axis of rotation 715 and a second axis of rotation 717, according to one example. Although not all components are necessarily shown, the electronic device 700a can be substantially similar to the electronic 600, as noted by similar reference numbers.

The electronic device 700a can include a band 704, a frame including a fixed portion 703 and a movable portion 705. The band 704 can be connected to the fixed portion 703. The electronic device 700a can include a display assembly positioned on the movable portion 705. The electronic device 700a can include a hinge 710a which can allow the movable portion 705 to be rotated with respect to the fixed portion 703 about the first axis of rotation 715 and the second axis of rotation 717. The first axis of rotation 715 is substantially perpendicular to the second axis of rotation 717.

The movable portion 705 can be rotatable about the first axis of rotation 715. The first axis of rotation 715 can be along an edge of the movable portion 705 and an edge of the fixed portion 703 that are adjacent to each other. Rotation of the movable portion 705 about the first axis of rotation 715 can adjust an angle between planes formed by inner displays 712 and 714.

The movable portion 705 can be rotatable about the second axis of rotation 717 corresponding to the hinge 710a. Rotation of the movable portion 705 about the second axis of rotation 717 can adjust an angle formed by the edge of the movable portion 705 and the edge of the fixed portion that are parallel to each other.

The hinge 710a can be a ball hinge joint, a swiveling hinge, a gimbal, or the like. In at least one example, the hinge 710a can include one or more stops, such as the stop 416 of FIG. 4, which prevent the rotation of the movable portion 705 with respect to the fixed portion 703 along either or both of the first or second axes of rotation 715 and 717.

Additionally or alternatively to the foregoing examples, in at least one implementation, the electronic device 700a can pivot about other axes. For instance, in one example, the fixed portion 703 can be positioned in-plane with a rotatable portion 718 (e.g., a circular base, platform, or interior core) that can rotate inside of the fixed portion 703. In yet another example, the fixed portion 703 can include a rotatable portion (e.g., a circular perimeter or torus-like structure, not shown) that can rotate outside of the fixed portion 703. In such an example, the fixed portion 703 and the rotatable portion 718 (as presently illustrated in FIG. 7) are positionally swapped such that the rotatable portion 718 is positioned exterior to the fixed portion 703. Thus, the fixed portion 703 may remain positionally fixed (e.g., relative to the band 704 or the movable portion 705), while another element positioned inside of or surrounding the fixed portion 703 can rotate. For example, a rotatable portion inside of or surrounding the fixed portion 703 can rotate in-plane to the fixed portion 703 about an axis 720 (which is perpendicular to the fixed portion 703). The depicted arrows indicate example movement of rotation for the rotatable portion 718 about the axis 720. In these or other examples, the rotatable portion 718 can include at least a portion of the display 714, and the fixed portion 703 can include at least a portion of the housing. In other examples, the rotatable portion 718 can include at least a portion of the housing, and the fixed portion 703 can include at least a portion of the display 714.

Further, in some examples, the hinge 710a (or another hinge as disclosed herein) can be positioned in an alternative arrangement than presently shown on a top side of the electronic device 700a. For example, the hinge 710a can be positioned on a lateral side (left or right) such that the movable portion 705 opens laterally like a book. In particular examples, the positional side of the hinge 710a may depend on whether the user is left-handed or right-handed (or wears the device on a left wrist versus a right wrist) such that the movable portion 705 opens in a convenient, ergonomic direction. Still, in other examples, the hinge 710a can be positioned on a bottom side (opposite of the present illustration shown in FIG. 7) such that the movable portion 705 can rotate or open towards the user rather than away from the user.

Other examples of rotatable portions and rotating configurations are herein contemplated. For example, as shown in FIGS. 7B-7C, the electronic device 700b includes a split base version of the fixed portion 703, where the fixed portion 703 includes a fixed base 722 and a rotatable platform 724. In this example, the fixed base 722 can maintain its positioning relative to the band 704 (and/or the user's wrist). In addition, the rotatable platform 724 can rotate about the axis 720 relative to the fixed base 722 (as expressly shown in FIG. 7B). Indeed, FIG. 7B shows the rotatable platform 724 (and the associated inner display 714) being rotated approximately fifteen degrees counterclockwise together with the inner display 712.

It will be appreciated that the partition (denoted pictorially via dashed lines on the fixed portion 703) between the fixed base 722 and the rotatable platform 724 can be positioned at different heights (e.g., to accommodate different features on the exterior and/or interior of the electronic device 700b). Indeed, the rotatable platform 724 can include a button, crown, or other exterior-accessible feature of the electronic device 700b (albeit FIGS. 7B-7C show the fixed base 722 including these features). For instance, in some implementations, the rotatable platform 724 includes a button, crown, or other exterior-accessible feature of the electronic device 700b such that sensitive components are not exposed to the environment (e.g., dust and water). To illustrate, electronic components associated with exterior-accessible features can be housed in the rotatable platform 724. In these or other examples, the fixed base 722 can include a cradle or underlying platform beneath the rotatable platform 724—where the rotatable platform 724 can include most (or all) of the electronics, as well as the main body and displays of the electronic device 700b.

As just mentioned, the inner displays 712, 714 can move together (i.e., in tandem, as denoted by the rotational arrows) as the rotatable platform 724 pivots about the axis 720. In FIG. 7B, a hinge 710b is shown as an expanded hinge with one degree of rotational freedom across an edge of the rotatable platform 724. The expanded hinge 710b in FIG. 7B can provide increased rigidity (e.g., such that a user can rotationally manipulate the movable portion 705, and in response, the rotatable platform 724 can correspondingly rotate with the movable portion 705 about the axis 720). Thus, the hinge 710b (or hinge 610) can be attached to the rotatable platform 724 such that both of the inner displays 712, 714 can rotate together (e.g., for providing a different viewing angle relative to the user) as the fixed base 722 remains positionally fixed on the user's wrist.

Once rotated (as shown in FIG. 7B), the rotatable platform 724 and the movable portion 705 can be rotated (automatically or manually) back to the position shown in FIG. 7C. The un-rotated position shown in FIG. 7C can correspond to one of many different positional configurations. In some examples, the rotatable platform 724 can be locked in the position shown in FIG. 7C. Additionally or alternatively, the rotatable platform 724 can be mechanically or magnetically biased to the position shown in FIG. 7C.

Rotation of the rotatable platform 724 relative to the fixed base 722 can be achieved in a variety of ways. For instance, in some examples, the rotatable platform 724 is rotatably coupled to the fixed base 722 via a detent coupling, a bearing coupling, a swivel coupling, a ball-and-socket coupling, a frictional coupling, etc. In these or other examples, the rotatable platform 724 can include fixed increments of rotational movement (e.g., increments of about two degrees, about five degrees, about fifteen degrees, about thirty degrees, and so forth). Alternatively, the rotatable platform 724 can include free rotational movement or infinite resolution of rotational degrees of freedom. In some examples, the rotatable platform 724 can rotate a full +/−360 degrees (as may be desired). In other examples, the rotatable platform 724 is rotatably bound via a mechanical stop or other mechanism so that rotation is bound between a range of angles (e.g., +/−about 15 degrees, +/−about 30 degrees, +/−about 60 degrees, +/−about 120 degrees, +/−about 180 degrees, +/−about 270 degrees, etc.). In this manner, a desired viewing angle and accessibility to the inner displays 712, 714 can be achieved.

It will be appreciated that the hinge 710b can be positioned at different locations. In some examples, the hinge 710b is coupled to the fixed base 722 (as opposed to the rotatable platform 724) such that rotational movement of the rotatable platform 724 (and hence the inner display 714) is decoupled from the inner display 712. The hinge 710b shown in FIG. 7C can provide for a variety of hinge connections and corresponding movements, as discussed above. Coupling the hinge 710b to the fixed base 722 can be advantageous in some scenarios. For example, a user can move a wrist or arm to point the inner display 712 (or the first camera 618 on an exterior portion of the device) in a first direction, while the user wishes to have a specific viewing angle of the inner display 714 that can be incongruent with the first direction. Accordingly, the electronic device 700b can provide many different positional configurations and allow adaptability in many different use cases.

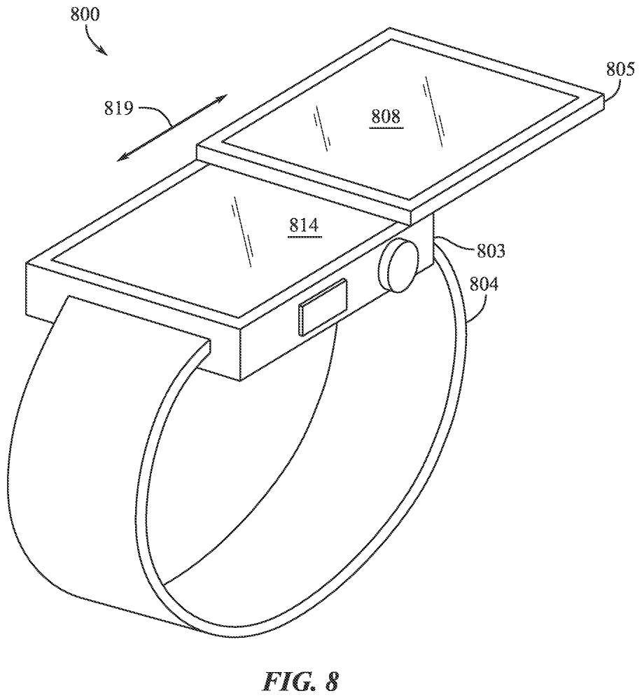

Any of the features, components, and/or parts, including the arrangements and configurations thereof shown in FIGS. 7A-7C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7A-7C. An example of a sliding electronic device is provided below in reference to FIG. 8.

FIG. 8 illustrates an electronic device 800 including a movable portion 805 which is slidable with respect to a fixed portion 803, according to one example. Although not all components are necessarily shown, the electronic device 800 can be substantially similar to the electronic devices 700a, 700b except that the movable portion slides, rather than rotates, with respect to the fixed portion.

The electronic device 800 can include a band, a frame including the fixed portion 803 and the movable portion 805. The band 804 can be connected to the fixed portion 803. The electronic device 800 can include a display assembly 808 positioned on the movable portion 805. The movable portion can include a display assembly 814. The electronic device 800 can include track (or set of tracks) which can allow the movable portion 805 to slide with respect to the fixed portion 803 along the track. The track can be parallel to planes formed by the display assemblies 808 and 814. In at least one example the movable portion 805 can be moved along the direction 819 to extend or contract the amount of the display assembly 814 which is visible.

Although FIG. 8 depicts the movable portion 805 sliding along the direction 819, in other examples, the tracks can be positioned such that the movable portion slides along a direction perpendicular to the direction 819.

Although not depicted, in some examples, the tracks can include a step at the position at which the movable portion 805 is fully extended from the fixed portion 803. The stop can allow the display assemblies 808 and 814 to be in the same plane when the electronic device 800 is fully extended. Additionally or alternatively, the tracks can include a hinge at the position at which the movable portion is fully extended from the fixed portion 803. The hinge can allow the movable portion 805 with respect to the fixed portion 803, such that an angle can be formed between the display assemblies 808 and 814.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A wearable electronic device, comprising:
a frame including a fixed portion and a movable portion;
an arm band connected to the fixed portion;
a display assembly positioned on the movable portion; and
an optical sensor positioned adjacent to the display assembly.

2. The wearable electronic device of claim 1, wherein the display assembly defines an aperture, and the optical sensor is optically aligned with the aperture.

3. The wearable electronic device of claim 1, wherein the display assembly comprises an outer display and the optical sensor faces outward with the outer display.

4. The wearable electronic device of claim 1, wherein the optical sensor is at least partially surrounded by an active display region of the display assembly.

5. The wearable electronic device of claim 1, further comprising an additional display assembly positioned on the fixed portion and on an inner side of the movable portion, the additional display assembly including an inner display.

6. The wearable electronic device of claim 5, wherein the inner display comprises a continuous display.

7. The wearable electronic device of claim 1, further comprising a hinge rotatably connecting the fixed portion and the movable portion.

8. The wearable electronic device of claim 7, wherein the movable portion is rotatable about a first axis of rotation relative to the fixed portion.

9. The wearable electronic device of claim 8, wherein the movable portion is rotatable about a second axis of rotation relative to the fixed portion, the second axis of rotation being perpendicular to the first axis of rotation.

10. The wearable electronic device of claim 1, further comprising a rotatable portion positioned in-plane with the fixed portion, the rotatable portion being rotatable about an axis perpendicular to the fixed portion.

11. A portable electronic device, comprising:
a housing including an exterior housing and an interior housing, the exterior housing defining an exterior opening and a first interior opening, and the interior housing defining a second interior opening;
a hinge rotatably connecting the exterior housing and the interior housing;
an exterior display positioned within the exterior opening, the exterior display defining a first camera aperture;
a first camera optically aligned with the first camera aperture;
an extended interior display opposite the exterior display and positioned within the first interior opening and the second interior opening, the extended interior display defining a second camera aperture; and
a second camera optically aligned with the second camera aperture.

12. The portable electronic device of claim 11, wherein the first camera and the second camera face in opposite directions.

13. The portable electronic device of claim 11, wherein a first field of view of the first camera and a second field of view of the second camera are adjustable via adjustment of the exterior housing.

14. The portable electronic device of claim 13, wherein a data representation of at least one of the first field of view or the second field of view is transmittable to an external client device.

15. The portable electronic device of claim 11, wherein the extended interior display includes a first display and a second display that is discrete and discontinuous from the first display.

16. The portable electronic device of claim 11, wherein the extended interior display includes a continuous display, the continuous display being configured to render a singular graphical representation.

17. A smartwatch, comprising:
a housing;
a movable display comprising a first side including a first display surface and a second side including a second display surface, the second side being opposite the first side, and the movable display connected to the housing and movable relative to the housing between an open state and a closed state;
a camera positioned on the movable display;
a display support attaching the movable display to the housing; and
a strap connected to the housing.

18. The smartwatch of claim 17, wherein the display support comprises a stop at a predetermined angle of the movable display relative to the housing.

19. The smartwatch of claim 17, wherein the display support pivotally attaches the movable display to the housing.

20. The smartwatch of claim 17, wherein the movable display includes a foldable display with a folding region positioned adjacent to the display support.
